(19) United States
(12) Patent Application Publication
(10) Pub. No.: US 2026/0256127 A1
(43) Pub. Date: Sep. 3, 2026

(54) INSECT CAPTURE AND ELIMINATION DEVICE HAVING TRANSPARENT STRIKING SURFACE WITH INTEGRATED VISUAL ALIGNMENT SYSTEM AND ADHESIVE CAPTURE SURFACE CONFIGURATIONS

(71) Applicant: Nicholas French, Douglas, MI (US)

(72) Inventor: Nicholas French, Douglas, MI (US)

(21) Appl. No.: 19/553,743

(22) Filed: Mar. 2, 2026

Related U.S. Application Data
(60) Provisional application No. 63/765,870, filed on Mar. 3, 2025.

(51) Int. Cl. A01M 3/02

(52) U.S. Cl. CPC A01M 3/022

(57) ABSTRACT

A fly swatter device includes an elongated handle and a swatter head comprising an optically transparent, non-porous, solid striking surface with a visual alignment aperture formed therethrough. The transparent striking surface enables the user to maintain continuous visual contact with a target insect throughout approach and striking motions, while the visual alignment aperture functions as an integrated sighting system for precise targeting. The non-porous striking surface resists entrapment of insect remains and facilitates cleaning. In an alternative embodiment, the swatter head comprises a raised perimeter containment wall defining a retention region in which a replaceable adhesive gel pad is disposed, enabling insect capture through adhesion rather than impact force. Both embodiments provide enhanced effectiveness for users with reduced visual acuity, limited mobility, or diminished hand-eye coordination.

### CROSS-REFERENCE TO RELATED APPLICATIONS

This application claims the benefit of U.S. Provisional Application Ser. No. 63/765,870, entitled “Improved Fly Swatter Device,” filed Mar. 3, 2025—all of which is hereby incorporated herein by reference in its entirety, including all references cited therein.

### COPYRIGHT NOTICE

This application includes material that is subject to copyright protection. The copyright owner has no objection to the facsimile reproduction by anyone of the patent disclosure, as it appears in the United States Patent and Trademark Office files or records, but otherwise reserves all copyright rights whatsoever.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates generally to handheld pest control implements, and more particularly to insect capture and elimination devices incorporating striking surfaces and adhesive capture surfaces for the dispatch and removal of flying and resting insects from residential, commercial, and institutional environments. Still more particularly, the present invention relates to fly swatter devices in which the striking surface comprises an optically transparent, non-porous, solid polymer material incorporating a visual alignment aperture that functions as an integrated sighting system, enabling the user to maintain continuous visual contact with the target insect throughout the approach and striking motion. The present invention further relates to fly swatter devices incorporating an adhesive gel pad retained within a containment structure on the swatter head, enabling capture and removal of insects through controlled adhesion rather than impact force. The present invention additionally relates to methods of targeting, eliminating, and capturing insects using such devices.

### 2. Background of the Invention

### 2.1 Description of the Related Art

The fly swatter is among the most ubiquitous and enduring pest control implements in human history. Since the introduction of the first commercially manufactured fly swatters in the early twentieth century, the fundamental design paradigm has remained remarkably unchanged: an elongated handle connected to a broad, thin striking surface, swung by the user to deliver a rapid impact against a target insect. For more than a century, this basic architecture has persisted with only superficial variation in materials, colors, and decorative ornamentation, while the core functional design—and its attendant limitations—has remained substantially unaddressed by the pest control industry.

The overwhelming majority of commercially available fly swatters employ a perforated or mesh striking surface, typically fabricated from a flexible polymer such as polyethylene or polypropylene, or from woven wire mesh mounted within a peripheral frame. The perforated design was originally adopted for a practical purpose: to reduce aerodynamic drag during the swatting motion, thereby enabling higher striking velocity with less physical effort. This design rationale has been so universally accepted that the perforated striking surface has become essentially the only commercially available configuration, with manufacturers treating it as an immutable design constraint rather than a variable subject to optimization.

However, the perforated striking surface introduces a constellation of functional deficiencies that have been tolerated rather than resolved. The openings in the mesh or perforated surface create a discontinuous contact interface between the striking surface and the target insect. Upon impact, the insect body is forced against and partially through the mesh openings, resulting in fragmentation of the insect remains and distribution of biological residue across the perforated surface. The fragmented remains—comprising hemolymph, visceral tissue, wing fragments, and appendage segments—become entrapped within and around the mesh openings, creating a surface that is inherently resistant to cleaning. The irregular geometry of perforations, wire junctions, and mesh interstices provides harborage for biological debris that is difficult to remove even with dedicated washing, resulting in progressive accumulation of insect residue and associated microbial colonization over repeated use cycles. The perforated fly swatter thus presents a fundamental hygienic contradiction: a device intended to improve the sanitary condition of an environment simultaneously becomes a reservoir of biological contamination with each successive use.

Beyond the hygiene deficiencies, the perforated striking surface creates a surface damage problem that has frustrated consumers and property owners for generations. When a conventional fly swatter is swung against a target insect positioned on a wall, window, ceiling, painted surface, or furnishing, the impact force required to dispatch the insect simultaneously drives the insect remains into the underlying surface. The resulting stain—a mixture of hemolymph, pigmented tissue, and appendage fragments—bonds to the surface through a combination of mechanical interlocking and chemical interaction between the proteinaceous insect residue and the surface substrate. On porous surfaces such as painted drywall, flat-finish interior paints, fabric upholstery, wallpaper, and acoustic ceiling tiles, the stain penetrates into the surface matrix and resists conventional cleaning methods. On non-porous surfaces such as glass, glossy paint finishes, and polished stone, the stain is more readily removable but still requires dedicated cleaning effort and may leave a perceptible residue upon casual inspection. The cumulative effect of repeated insect impacts over time degrades the aesthetic appearance of interior surfaces, particularly in areas of high insect activity such as kitchens, dining areas, and exterior-adjacent rooms with frequent door and window openings.

A further limitation inherent in conventional fly swatter design is the targeting deficiency that fundamentally undermines the device's effectiveness. The act of swatting a flying or resting insect requires the user to visually acquire the target, estimate its position relative to the striking surface, initiate a rapid swinging motion, and deliver the striking surface to the target location within a time window that is governed by the insect's reaction time—which, in the case of the common housefly (Musca domestica), is approximately 100 to 200 milliseconds from visual detection of an approaching threat to initiation of an evasive flight response. This demanding psychomotor task requires the coordinated integration of visual acuity, hand-eye coordination, spatial estimation, and rapid motor execution. Critically, the conventional fly swatter provides no mechanical aid to any of these requirements. The striking surface is opaque or, at best, semi-transparent due to its mesh or perforated construction, which partially or fully obscures the user's view of the target insect during the final phase of the approach and striking motion—precisely the moment at which visual feedback is most critical for accurate targeting. The user must therefore estimate the insect's position from peripheral visual cues and commit to the strike trajectory without real-time visual confirmation, resulting in a substantial miss rate even among users with normal psychomotor function.

The targeting deficiency of conventional fly swatters is particularly pronounced among aging populations and individuals with diminished physical capabilities. The demographic profile of the developed world is shifting markedly toward older age cohorts, with the population aged 65 and older projected to represent an increasingly substantial share of households in the United States, Europe, and East Asia. Aging is associated with well-documented declines in visual acuity, contrast sensitivity, peripheral visual field extent, hand-eye coordination speed, motor reaction time, grip strength, and upper extremity range of motion. Each of these age-related changes directly and adversely impacts the user's ability to execute the rapid, coordinated striking motion required by a conventional fly swatter. Individuals with arthritis, neuropathy, Parkinson's disease, or post-stroke motor deficits face compounded difficulty. The net result is that the conventional fly swatter becomes progressively less effective—and progressively more frustrating—for the very population that spends the most time in residential environments where flying insects are encountered. This demographic reality represents a substantial and growing unmet need that conventional fly swatter designs are architecturally incapable of addressing.

Various alternative pest control devices have been developed in attempts to overcome one or more of the foregoing deficiencies, but each alternative introduces its own set of limitations that have prevented widespread adoption as a replacement for the conventional fly swatter. Electrically powered insect elimination devices, including handheld electric swatters incorporating electrified wire grids and stationary ultraviolet-light attractant traps, require batteries or electrical power sources, present electrical shock hazards particularly in households with children and pets, and are significantly more expensive than conventional fly swatters. Vacuum-based insect capture devices employ suction to entrain insects into a collection chamber, but require power sources, generate noise that may alert and disperse target insects, and are bulky relative to the simplicity of a handheld swatter. Adhesive tape strips and adhesive surface traps operate passively by attracting and entrapping insects on an exposed adhesive surface, but are aesthetically objectionable in visible areas of the home, lack the active targeting capability that enables the user to eliminate a specific insect on demand, and become contaminated with dust and debris that progressively diminish their adhesive effectiveness. Chemical insecticide sprays provide effective insect elimination but introduce toxic or irritant compounds into the indoor environment, may contaminate food preparation surfaces, are contraindicated for use around individuals with respiratory sensitivities, and raise increasing consumer concern regarding environmental and health impacts of chemical pesticide exposure in residential settings.

None of the foregoing alternative devices successfully combines the fundamental advantages that have sustained the conventional fly swatter's market dominance for over a century—namely, simplicity of construction, absence of power source requirements, low unit cost, portability, immediate readiness for use without setup or preparation, and active user-directed targeting capability—while simultaneously overcoming the hygiene, surface damage, and targeting accuracy limitations that represent the conventional fly swatter's most persistent functional deficiencies.

### 2.2 Problems in the Art

In view of the foregoing, several specific and commercially significant problems persist in the art of handheld insect elimination devices. First, there exists no commercially available fly swatter device that provides the user with continuous, unobstructed visual contact with the target insect throughout the entirety of the approach and striking motion, thereby enabling real-time visual alignment between the striking surface and the target at the moment of impact. Second, there exists no commercially available fly swatter device incorporating a striking surface that is simultaneously non-porous, optically transparent, and configured with a sighting feature that functions as an integrated visual alignment system. Third, there exists no commercially available fly swatter device that addresses the combined targeting and hygiene deficiencies of conventional designs within a single, simple, unpowered handheld implement. Fourth, there exists no commercially available fly swatter device that offers alternative functional modalities—specifically, impact elimination and adhesive capture—within a common design platform, enabling the user to select the insect dispatch method most appropriate to the particular situation and the user's physical capabilities.

These and other objects of the present invention will become apparent in light of the present specification, claims, and drawings.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The present invention provides fly swatter devices and associated configurations that overcome the shortcomings of the prior art. More specifically, the present invention provides insect capture and elimination devices in which the swatter head incorporates either an optically transparent, non-porous, solid striking surface with an integrated visual alignment aperture, or an adhesive gel pad retained within a containment structure, each configuration addressing distinct functional deficiencies that have persisted in conventional fly swatter designs for more than a century.

In a first embodiment, the present invention provides a fly swatter device comprising an elongated handle having a proximal end and a distal end, and a swatter head connected to the proximal end of the elongated handle. The swatter head comprises a substantially planar striking surface that is optically transparent, non-porous, and solid. A visual alignment aperture is formed through the striking surface and positioned to enable a user to maintain visual contact with a target insect through the striking surface during approach and striking motions, whereby the visual alignment aperture functions as an integrated sighting system for aligning the striking surface with the target insect.

The transparent, non-porous construction of the striking surface represents a departure from the perforated mesh paradigm that has dominated fly swatter design since the early twentieth century. Because the striking surface is solid and free of perforations, mesh openings, and interstices, insect remains upon impact are deposited on a smooth, continuous exterior surface from which they may be readily removed by simple wiping, without the progressive accumulation of biological debris that characterizes conventional perforated designs. The optical transparency of the striking surface further distinguishes the present invention from the prior art by enabling the user to see through the swatter head throughout the entirety of the approach and striking motion, providing real-time visual feedback that substantially improves targeting accuracy relative to opaque or semi-transparent conventional striking surfaces.

The visual alignment aperture cooperates with the transparent striking surface to provide a two-component sighting system. The transparent field of the striking surface provides broad-area visual awareness of the target insect's position, while the aperture provides a focused alignment reference within that field, analogous to the relationship between a rear sight and a front sight in aiming systems. This cooperative sighting functionality enables more deliberate, controlled approach speeds and reduces the reliance on rapid reflexive striking that characterizes conventional fly swatter use.

The visual alignment aperture may be substantially oval or elliptical in configuration, or substantially circular in configuration. The aperture geometry may be selected to optimize the balance between sighting field of view and structural continuity of the striking surface for a given swatter head size.

To further enhance the visual alignment function, the striking surface may incorporate visual alignment indicia disposed on or adjacent the striking surface surrounding the visual alignment aperture. Suitable visual alignment indicia include concentric rings, crosshair markings, contrasting-color annular zones, radial tick marks, and combinations thereof. The visual alignment indicia provide supplemental visual reference features that assist the user in centering the target insect within the sighting field during the approach motion.

The striking surface preferably comprises a transparent polymer having a visible light transmittance of at least approximately 80 percent as measured in accordance with ASTM D1003. Suitable transparent polymers include polycarbonate, polymethyl methacrylate, clarified polypropylene, cyclic olefin copolymer, styrene-acrylonitrile copolymer, and combinations thereof. The transparent polymer preferably incorporates a UV stabilizer configured to resist photodegradation and yellowing of the striking surface over prolonged exposure to ultraviolet radiation, thereby maintaining the optical clarity and visual alignment function of the device over its intended service life.

Structural integrity of the swatter head is addressed through a graduated thickness profile in which the striking surface is thicker at a head-to-handle transition zone where the swatter head connects to the elongated handle and progressively thinner toward a distal perimeter of the swatter head. This graduated profile provides structural rigidity where mechanical stress concentrates during the striking motion while permitting controlled flexibility at the distal perimeter, enabling the striking surface to conform to the contour of the target surface upon impact and distribute impact force over a broader contact area.

Hygiene considerations beyond the non-porous surface design are addressed through incorporation of an antimicrobial agent distributed within the polymer matrix of at least one of the striking surface and the elongated handle. Suitable antimicrobial agents include silver ion compounds, zinc pyrithione, copper-based antimicrobial compounds, and combinations thereof. The antimicrobial agent inhibits microbial colonization on the device surfaces between cleaning events, complementing the ease-of-cleaning benefit provided by the non-porous striking surface construction.

The elongated handle preferably comprises a first polymer material having a first flexural rigidity, and the striking surface preferably comprises a second polymer material having a second flexural rigidity less than the first flexural rigidity. This differential rigidity ensures that the handle resists deflection during a striking motion, providing the user with positive control over strike trajectory, while the striking surface exhibits controlled flexibility upon impact with a target surface, reducing the risk of damage to the underlying surface and improving conformity between the striking surface and the target surface. The swatter head is preferably integrally formed with the elongated handle as a unitary molded structure, and the swatter head preferably comprises a polygonal peripheral outline having at least five straight edges. The elongated handle preferably includes a hanging aperture formed through the distal end thereof for suspended storage of the device.

A second embodiment of the present invention provides a fly swatter device comprising an elongated handle connected to a swatter head, the swatter head comprising a substantially planar base surface bounded by a raised perimeter containment wall. The raised perimeter containment wall and the base surface together define a retention region in which an adhesive gel pad is disposed. The adhesive gel pad has an exposed adhesive capture surface configured to capture and retain insects through adhesion upon contact with the target insect without requiring impact force sufficient to eliminate the insect.

The adhesive capture approach represents a fundamentally different operational paradigm from the impact elimination approach of both conventional fly swatters and the first embodiment of the present invention. Rather than requiring the user to generate sufficient velocity and force to dispatch the target insect upon impact, the adhesive embodiment requires only that the user bring the exposed adhesive capture surface into contact with the target insect at any speed and with minimal force. This low-force, low-speed operational mode is particularly advantageous for elderly users, individuals with reduced grip strength or upper extremity range of motion, and individuals with motor control deficiencies that impair the rapid, coordinated striking motion required by conventional fly swatters.

The adhesive gel pad is preferably removably disposed within the retention region and is replaceable by a user, enabling extended device life through periodic replacement of the consumable adhesive element while retaining the durable handle and swatter head structure. The raised perimeter containment wall preferably defines a recessed channel dimensioned to receive and mechanically retain the adhesive gel pad, securing the pad against unintended detachment during normal use. The adhesive gel pad preferably comprises a non-toxic, non-drying adhesive formulation and further incorporates an antimicrobial agent configured to inhibit microbial colonization of captured insect remains on the exposed adhesive capture surface.

Both embodiments of the present invention share a common design platform characterized by an elongated ergonomic handle with a hanging aperture at the distal end, a swatter head connected at the proximal end, and a non-porous contact surface that resists entrapment of biological debris. This shared platform enables manufacturing economies and provides the consumer with the option of selecting the functional modality—precision impact elimination or adhesive capture—best suited to the user's physical capabilities, the particular insect encounter scenario, and personal preference.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted.

It will be further understood that the invention is not necessarily limited to the particular embodiments illustrated herein.

The invention will now be described with reference to the drawings wherein:

FIG. 1 is a perspective view of a fly swatter device incorporating an optically transparent striking surface and a visual alignment aperture in accordance with a first embodiment of the present invention.

FIG. 2 is a top plan view of the fly swatter device of FIG. 1.

FIG. 3 is a side elevation view of the fly swatter device of FIG. 1.

FIG. 4 is a perspective view of a fly swatter device incorporating an adhesive gel pad retained within a containment structure in accordance with a second embodiment of the present invention.

FIG. 5 is a top plan view of the fly swatter device of FIG. 4, showing the adhesive gel pad disposed within the retention region of the swatter head.

FIG. 6 is a bottom plan view of the fly swatter device of FIG. 4, showing a flexibility slot formed in the underside of the swatter head.

FIG. 7 is a side elevation view of the fly swatter device of FIG. 4.

FIG. 8 is a cross-sectional detail view of the swatter head of the fly swatter device of FIG. 4.

### REFERENCE NUMERALS

Reference numerals used throughout the detailed description and drawings correspond to the following elements:

### Shared Elements

10—fly swatter device
12—elongated handle
14—proximal end of elongated handle
16—distal end of elongated handle
18—swatter head
20—hanging aperture

### First Embodiment—Visual Alignment Striking Surface

22—striking surface
24—visual alignment aperture
26—visual alignment indicia
28—head-to-handle transition zone
30—distal perimeter of swatter head
32—peripheral edge

### Second Embodiment—Adhesive Gel Pad

34—base surface
36—raised perimeter containment wall
38—retention region
40—adhesive gel pad
42—exposed adhesive capture surface
44—recessed channel
46—flexibility slot

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

As used herein, the term “approximately” when used in connection with a numerical value means within plus or minus ten percent (±10%) of the stated value. It will be understood that where numerical values are expressed as approximations through use of the term “approximately,” the particular values form additional embodiments of the invention.

As used herein, the term “optically transparent” means that the referenced material permits transmission of visible light sufficient to enable a user to discern the shape, position, and movement of a target insect through the material under normal indoor and outdoor lighting conditions. Quantitatively, an optically transparent material as used herein exhibits a visible light transmittance of at least approximately 70 percent, and preferably at least approximately 80 percent, as measured in accordance with ASTM D1003. As used herein, the term “optically translucent” means that the referenced material permits transmission of diffused visible light sufficient to enable a user to discern the general position and approximate outline of a target insect through the material under normal indoor and outdoor lighting conditions, but without the degree of image clarity and sharpness characteristic of an optically transparent material. Quantitatively, an optically translucent material as used herein exhibits a visible light transmittance of from at least approximately 40 percent to less than approximately 70 percent, as measured in accordance with ASTM D1003. It will be understood that where the present specification and claims recite an “optically transparent” material, embodiments employing an “optically translucent” material are also contemplated within the scope of the invention unless expressly excluded, and that the terms “optically transparent” and “optically translucent” may be collectively referred to herein as “light-transmissive.”

As used herein, the term “non-porous” means that the referenced surface is substantially free of through-holes, perforations, mesh openings, slots, or other apertures that would permit passage of insect remains, biological fluids, or particulate debris through the surface, with the sole exception of any visual alignment aperture expressly recited herein.

As used herein, the term “solid” when used to describe the striking surface means that the striking surface comprises a continuous, uninterrupted polymer body throughout its cross-sectional thickness, as distinguished from hollow, cellular, foamed, laminated, or mesh constructions.

It will be understood that when a Markush group or other grouping is used herein, all individual members of the group and all combinations and sub-combinations possible from the grouping are intended to be individually included in the disclosure. The term “and/or” when used in a list of two or more items means that any one of the listed items can be employed by itself, or any combination of two or more of the listed items can be employed. When the term “independently” is used to modify members of a group, it means that each member may be the same as or different from any other member within that group.

As used herein, the terms “preferably” and “most preferably” indicate progressively narrowed embodiments of the invention that are particularly contemplated by the inventors, without limiting the scope of the invention to those embodiments. As used herein, the terms “comprising,” “including,” and “containing” shall be read expansively and without limitation. It will be understood that when a Markush group or other grouping is used herein, all individual members of the group and all combinations and sub-combinations possible from the grouping are intended to be individually included in the disclosure. The term “and/or” when used in a list of two or more items means that any one of the listed items can be employed by itself, or any combination of two or more of the listed items can be employed. When the term “independently” is used to modify members of a group, it means that each member may be the same as or different from any other member within that group.

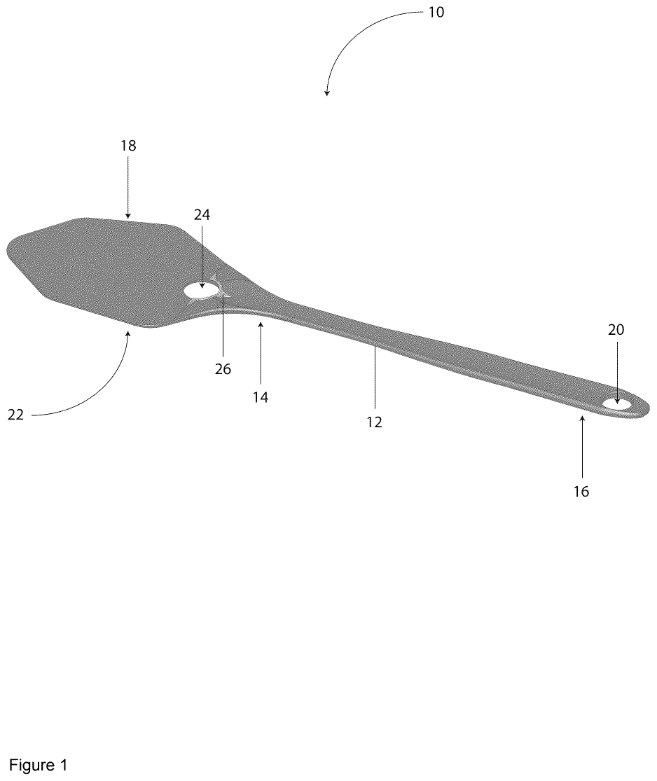

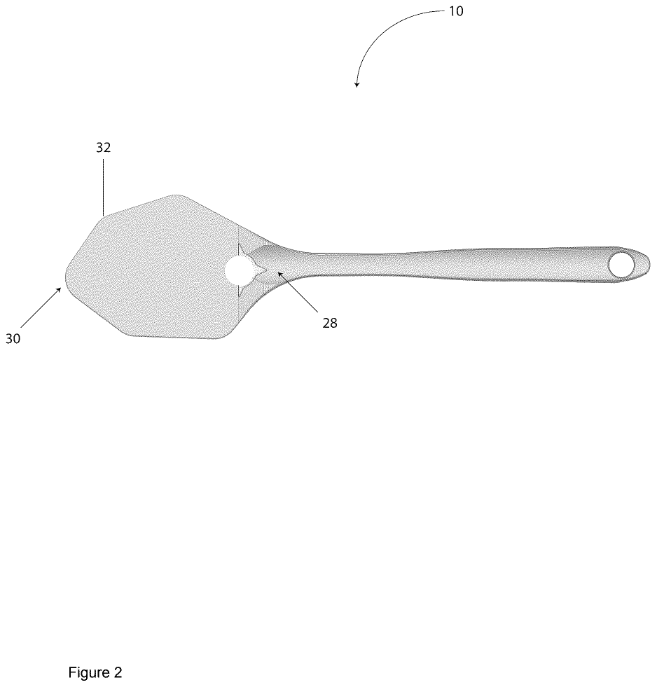

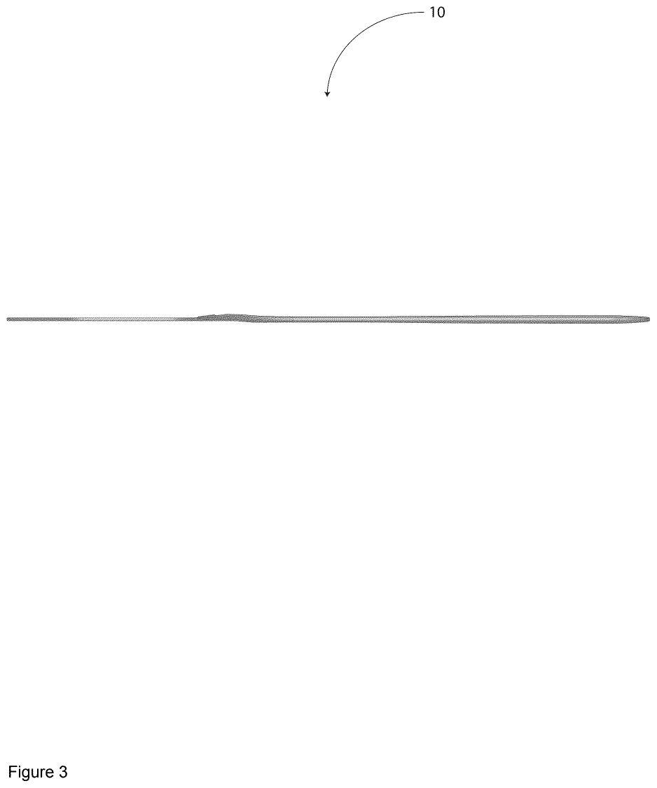

Referring now collectively to FIGS. 1 through 3, there is shown a fly swatter device 10 in accordance with a first embodiment of the present invention. Fly swatter device 10 is specifically engineered for the precision elimination of flying and resting insects through a combination of an optically transparent, non-porous, solid striking surface and an integrated visual alignment system that enables the user to maintain continuous visual contact with a target insect throughout the approach and striking motions. FIG. 1 is a perspective view illustrating the overall three-dimensional form of fly swatter device 10. FIG. 2 is a top plan view illustrating the planar geometry of the swatter head and the position of the visual alignment aperture within the striking surface. FIG. 3 is a side elevation view illustrating the thin, substantially planar profile of the swatter head and the elongated handle extending therefrom.

Fly swatter device 10 includes an elongated handle 12 having a proximal end 14 and a distal end 16. Elongated handle 12 extends along a longitudinal axis between proximal end 14 and distal end 16 and is configured to be grasped by a user's hand during operation of the device. Elongated handle 12 is preferably of a length sufficient to provide the user with adequate reach and leverage during a striking motion, and is preferably from approximately 6 inches to approximately 18 inches in length measured from proximal end 14 to distal end 16, more preferably from approximately 8 inches to approximately 14 inches, and most preferably from approximately 10 inches to approximately 12 inches. The cross-sectional profile of elongated handle 12 may be circular, oval, rectangular with rounded corners, or any other ergonomic cross-sectional shape that provides a secure and comfortable grip. Elongated handle 12 may further include contoured regions, textured surfaces, or ergonomic indentations to enhance grip security and comfort during use.

A swatter head 18 is connected to proximal end 14 of elongated handle 12. In a preferred embodiment, swatter head 18 is integrally formed with elongated handle 12 as a unitary molded structure, such that the handle and the swatter head comprise a single, continuous polymer body produced in a single molding operation. The unitary construction eliminates joints, fasteners, and adhesive interfaces between the handle and the swatter head, providing enhanced structural integrity and eliminating potential failure points at the handle-to-head junction. In alternative embodiments, swatter head 18 may be separately manufactured and subsequently attached to elongated handle 12 through mechanical fastening, adhesive bonding, ultrasonic welding, insert molding, overmolding, or other appropriate joining techniques.

A hanging aperture 20 is formed through distal end 16 of elongated handle 12. Hanging aperture 20 is configured to receive a hook, nail, fastener, cord, or other suspension element for convenient suspended storage of fly swatter device 10 when not in use. Hanging aperture 20 is preferably oblong or elongated oval in configuration, although circular, rectangular, or other aperture geometries are contemplated within the scope of the invention. The provision of hanging aperture 20 at distal end 16 positions the hanging point at the end of the device opposite the swatter head, such that fly swatter device 10 hangs vertically with swatter head 18 in a downward orientation during storage, maintaining the device in a readily accessible position for immediate use.

Referring again to FIGS. 1 through 3, swatter head 18 comprises a striking surface 22. Striking surface 22 is substantially planar in configuration and defines the primary contact surface of fly swatter device 10 that engages the target insect during a striking motion. Striking surface 22 is optically transparent, non-porous, and solid. The optical transparency of striking surface 22 enables the user to see through the swatter head 18 throughout the entirety of the approach and striking motion, providing continuous, real-time visual feedback regarding the position of the target insect relative to the striking surface. This visual feedback represents a fundamental functional departure from conventional fly swatter designs in which the striking surface is opaque or, at best, semi-transparent due to the presence of mesh, perforations, or pigmented polymer materials that partially or fully obscure the user's view of the target during the critical final phase of the approach. In alternative embodiments, striking surface 22 may be optically translucent rather than optically transparent, as those terms are defined herein. An optically translucent striking surface permits the user to discern the general position and approximate outline of the target insect through the striking surface, providing a degree of visual feedback during the approach and striking motion that is superior to the fully opaque striking surfaces of conventional fly swatter designs, while potentially offering enhanced impact resistance, reduced manufacturing cost, or aesthetic variation relative to a fully transparent material. It will be understood that where the present description refers to striking surface 22 as optically transparent, embodiments in which striking surface 22 is optically translucent or in which striking surface 22 incorporates both optically transparent and optically translucent regions are also contemplated within the scope of the invention. These characteristics apply to the entire fly swatter device 10—not just the striking surface.

The non-porous character of striking surface 22 means that striking surface 22 is substantially free of through-holes, perforations, mesh openings, slots, or other apertures that would permit passage of insect remains, biological fluids, or particulate debris through the striking surface, with the sole exception of visual alignment aperture 24 as described herein. Because striking surface 22 presents a smooth, continuous, uninterrupted exterior surface on both its front face and its rear face, insect remains deposited upon impact are confined to the exterior surface and do not become entrapped within or forced through openings in the striking surface. This smooth, continuous surface geometry enables the user to remove insect remains from striking surface 22 by simple wiping with a cloth, paper towel, or other cleaning medium, without the need for scrubbing, picking, or other intensive cleaning efforts that are required to remove fragmented insect remains from the mesh openings and interstices of conventional perforated fly swatters. The non-porous construction thereby addresses the fundamental hygienic deficiency identified in the Background of the Invention —namely, the progressive accumulation of biological debris and associated microbial colonization that characterizes conventional perforated striking surfaces over repeated use cycles.

The solid construction of striking surface 22 means that striking surface 22 comprises a continuous, uninterrupted polymer body throughout its cross-sectional thickness. Striking surface 22 is not hollow, cellular, foamed, laminated, or of mesh construction. The solid construction contributes to the structural integrity and impact resistance of the striking surface while maintaining the optical transparency required for the visual alignment function described herein. The solid construction further ensures that the striking surface presents a consistent, uniform contact interface to the target insect upon impact, distributing impact force across the contact area rather than concentrating force at the edges of mesh openings or perforations as occurs in conventional designs.

Striking surface 22 preferably comprises a transparent polymer having a visible light transmittance of at least approximately 80 percent as measured in accordance with ASTM D1003. Suitable transparent polymers for striking surface 22 include, but are not limited to, polycarbonate, polymethyl methacrylate (commonly referred to as acrylic), clarified polypropylene, cyclic olefin copolymer, styrene-acrylonitrile copolymer, and combinations thereof. The selection of a particular transparent polymer for striking surface 22 may be guided by the desired balance of optical clarity, impact resistance, flexural stiffness, chemical resistance, and manufacturing processability for a given application.

Polycarbonate offers exceptional impact resistance and good optical clarity, making it particularly suitable for applications where durability under repeated high-force impacts is prioritized. Polymethyl methacrylate offers superior optical clarity with a visible light transmittance that may exceed 92 percent, but exhibits lower impact resistance than polycarbonate and may be more susceptible to brittle fracture upon repeated impact loading. Clarified polypropylene offers good chemical resistance, low density, and favorable economics for high-volume injection molding production, with visible light transmittance values that may range from approximately 80 to approximately 90 percent depending upon the clarifying agent and processing conditions. Cyclic olefin copolymer offers excellent optical clarity, low moisture absorption, and dimensional stability. Styrene-acrylonitrile copolymer offers good optical clarity combined with enhanced chemical resistance relative to unmodified polystyrene. In a preferred embodiment, striking surface 22 comprises polycarbonate. In an alternative preferred embodiment, striking surface 22 comprises clarified polypropylene. The foregoing list of suitable transparent polymers is illustrative and not limiting; any polymer material that satisfies the optical transparency, non-porous, and solid requirements set forth herein may be employed within the scope of the present invention.

Striking surface 22 preferably incorporates a UV stabilizer configured to resist photodegradation and yellowing of the striking surface over prolonged exposure to ultraviolet radiation. Fly swatter devices are commonly stored in locations that receive direct or indirect sunlight, including hanging on wall hooks near windows, stored on countertops, or placed in outdoor-adjacent areas such as porches and patios. Prolonged ultraviolet exposure can cause photolytic chain scission and photooxidative degradation of many transparent polymers, resulting in progressive yellowing, hazing, and loss of optical clarity that would impair the visual alignment function of the device over its intended service life. Suitable UV stabilizers include, but are not limited to, benzotriazole-type UV absorbers, hydroxyphenyl-triazine UV absorbers, hindered amine light stabilizers (HALS), and combinations thereof. The UV stabilizer is preferably incorporated into the polymer matrix of striking surface 22 during compounding or molding, and is preferably present in an amount of from approximately 0.1 to approximately 2.0 percent by weight of the polymer composition, more preferably from approximately 0.2 to approximately 1.0 percent by weight.

Referring again to FIGS. 1-3, a visual alignment aperture 24 is formed through striking surface 22. Visual alignment aperture 24 extends completely through the thickness of striking surface 22, providing an unobstructed line of sight from the front face of striking surface 22 through to the rear face. Visual alignment aperture 24 is positioned within striking surface 22 at a location between a head-to-handle transition zone 28 and a distal perimeter 30 of swatter head 18. In a preferred embodiment, visual alignment aperture 24 is positioned proximate to head-to-handle transition zone 28, generally in the region where swatter head 18 begins to widen from the narrower cross-section of elongated handle 12 into the broader planar area of the swatter head. This positioning places visual alignment aperture 24 in the central sighting field of the user's vision during a natural forehand or overhead striking motion, optimizing the ergonomic utility of the sighting function.

Visual alignment aperture 24 is configured to enable a user to maintain visual contact with a target insect through striking surface 22 during approach and striking motions. In operation, the user holds fly swatter device 10 by elongated handle 12, positions swatter head 18 between the user's eyes and the target insect, and visually acquires the target insect through the optically transparent striking surface 22. As the user initiates the approach motion, the target insect remains visible through the transparent field of striking surface 22 while visual alignment aperture 24 provides a focused reference point within that field. The user aligns visual alignment aperture 24 with the target insect by adjusting the approach trajectory such that the target insect appears within or immediately adjacent visual alignment aperture 24 as seen through the transparent striking surface. This alignment relationship is maintained throughout the final approach and striking motion, providing the user with continuous, real-time visual confirmation that the striking surface is on a trajectory to contact the target insect. The cooperative visual function of transparent striking surface 22 and visual alignment aperture 24 thereby constitutes an integrated sighting system—analogous in principle to the relationship between a rear sight aperture and a front sight post in aiming systems—that is absent from all known prior art fly swatter designs. Furthermore, the integrated sighting system encourages the user to adopt a slower, more controlled approach trajectory rather than a rapid swinging motion, which may reduce the rate of apparent visual expansion of the device as perceived by the target insect and thereby delay the insect's looming-triggered evasive flight response, providing the user with an extended targeting window relative to conventional rapid-strike techniques.

Visual alignment aperture 24 is preferably substantially oval or elliptical in configuration, although substantially circular configurations and other geometries including oblong, teardrop, and polygonal configurations are contemplated within the scope of the invention. The major axis dimension of visual alignment aperture 24 is preferably from approximately 0.25 inches to approximately 1.5 inches, more preferably from approximately 0.375 inches to approximately 1.0 inch, and most preferably from approximately 0.5 inches to approximately 0.75 inches. The minor axis dimension of visual alignment aperture 24, in embodiments where the aperture is non-circular, is preferably from approximately 60 percent to approximately 100 percent of the major axis dimension. The dimensions of visual alignment aperture 24 represent a balance between competing functional requirements: a larger aperture provides a broader sighting field that facilitates initial visual acquisition of the target insect, while a smaller aperture provides a more precise alignment reference that improves targeting accuracy during the final phase of the striking motion. Additionally, the dimensions of visual alignment aperture 24 must be selected to maintain adequate structural continuity of striking surface 22 in the region surrounding the aperture, avoiding excessive stress concentration that could initiate fracture propagation during repeated impact loading.

Referring still to FIGS. 1-3, fly swatter device 10 preferably further comprises visual alignment indicia 26 disposed on or adjacent striking surface 22 surrounding visual alignment aperture 24. Visual alignment indicia 26 are configured to enhance visual targeting of the target insect by providing supplemental visual reference features that assist the user in centering the target insect within the sighting field defined by visual alignment aperture 24 during the approach motion. Suitable visual alignment indicia 26 include, but are not limited to, concentric rings disposed concentrically about visual alignment aperture 24, crosshair markings extending radially from visual alignment aperture 24, contrasting-color annular zones surrounding visual alignment aperture 24, radial tick marks disposed at angularly spaced positions about the periphery of visual alignment aperture 24, and combinations thereof.

Visual alignment indicia 26 may be formed on or in striking surface 22 by any suitable technique including, but not limited to, molding the indicia directly into the surface of striking surface 22 during the injection molding process, pad printing, screen printing, laser engraving, ink-jet printing, application of adhesive decals, hot stamping, or painting through a mask or stencil. In embodiments where striking surface 22 is optically transparent, visual alignment indicia 26 are preferably formed using a contrasting color or opacity that is readily distinguishable against the transparent background of striking surface 22 under normal lighting conditions, while occupying a sufficiently limited area that the indicia do not materially impair the overall optical transparency of striking surface 22 or obstruct the user's view of the target insect during approach. In a preferred embodiment, visual alignment indicia 26 comprise a starburst or multi-pointed radial pattern disposed symmetrically about visual alignment aperture 24, providing radial directional cues that guide the user's eye toward the center of the aperture. In certain embodiments, visual alignment indicia 26 may be formed from a material that is visible under normal lighting conditions and additionally exhibits fluorescent or phosphorescent properties that enhance visibility under low-light conditions. In alternative embodiments, the visual alignment function may be provided by visual alignment indicia 26 alone, without visual alignment aperture 24. In such embodiments, visual alignment indicia 26 comprise one or more printed, molded, engraved, or applied markings disposed on striking surface 22 at a designated sighting region, the markings configured to provide the user with a visual reference for aligning the striking surface with the target insect during approach and striking motions. Suitable standalone visual alignment indicia include, but are not limited to, a bullseye target pattern, concentric rings, crosshair markings, a contrasting-color central zone, a dot or circle of contrasting color, or any combination thereof. In such embodiments, the optically transparent or optically translucent character of striking surface 22 cooperates with the standalone visual alignment indicia to enable the user to see the target insect through the striking surface while using the indicia as an alignment reference, without the need for a physical aperture extending through the striking surface. The absence of a physical aperture in such embodiments preserves the full structural continuity of striking surface 22, which may enhance impact resistance and fatigue life relative to embodiments incorporating an aperture.

Referring now to FIGS. 1 through 3, and particularly to FIGS. 2 and 3, swatter head 18 defines a head-to-handle transition zone 28 at the juncture where swatter head 18 connects to proximal end 14 of elongated handle 12. Head-to-handle transition zone 28 represents the structural region in which the relatively narrow cross-sectional geometry of elongated handle 12 transitions into the broader, thinner planar geometry of swatter head 18. During a striking motion, the inertial forces generated by the acceleration and deceleration of swatter head 18 are transmitted through head-to-handle transition zone 28, which thereby experiences the highest bending moment and shear stress of any region in fly swatter device 10. Head-to-handle transition zone 28 is accordingly a critical structural region that substantially influences the durability, service life, and perceived quality of the device. Failure at or near head-to-handle transition zone 28—manifesting as cracking, fracture, permanent deformation, or progressive fatigue—is among the most common failure modes observed in conventional fly swatter devices, particularly in low-cost commodity designs that employ thin, uniform-thickness construction without structural reinforcement at this critical juncture.

The present invention addresses the structural demands at head-to-handle transition zone 28 through a graduated thickness profile of striking surface 22. Striking surface 22 is thicker at head-to-handle transition zone 28 and progressively thinner toward a distal perimeter 30 of swatter head 18. The graduated thickness profile distributes material where it is most needed for structural performance—at the high-stress transition zone—while minimizing material and mass at the distal perimeter where aerodynamic considerations and impact dynamics favor a thinner cross-section. The thicker construction at head-to-handle transition zone 28 provides the rigidity and fatigue resistance necessary to withstand repeated striking cycles without fracture or permanent deformation, while the thinner construction at distal perimeter 30 permits controlled flexibility of striking surface 22 upon impact with a target surface. This controlled flexibility enables striking surface 22 to conform to the contour of the target surface—whether flat, curved, textured, or irregular—at the moment of impact, distributing the impact force over a broader contact area, reducing peak contact stress on the underlying surface, and thereby reducing the risk of damage to walls, windows, painted finishes, and other surfaces against which insects are commonly dispatched.

The graduated thickness profile of striking surface 22 preferably transitions from a maximum thickness at head-to-handle transition zone 28 of from approximately 2.0 mm to approximately 6.0 mm, more preferably from approximately 3.0 mm to approximately 5.0 mm, to a minimum thickness at distal perimeter 30 of from approximately 0.5 mm to approximately 2.5 mm, more preferably from approximately 0.8 mm to approximately 1.5 mm. The transition between the maximum and minimum thicknesses is preferably gradual and continuous, without abrupt steps or discontinuities that would create stress concentration points susceptible to crack initiation under cyclic impact loading. In a preferred embodiment, the graduated thickness profile follows a substantially linear taper from head-to-handle transition zone 28 to distal perimeter 30. In alternative embodiments, the graduated thickness profile may follow a curvilinear taper, a stepped taper with blended transition regions, or a compound taper having different taper rates in different regions of the swatter head. The side elevation view of FIG. 3 illustrates the thin, substantially planar profile of swatter head 18 including the graduated thickness characteristic.

Swatter head 18 is preferably bounded by a peripheral edge 32 that defines the outer boundary of striking surface 22. Peripheral edge 32 preferably defines a polygonal peripheral outline having at least five straight edges. In a preferred embodiment, peripheral edge 32 defines a pentagonal or hexagonal peripheral outline that provides a broad striking area while accommodating the structural geometry of head-to-handle transition zone 28 and the taper from the handle width to the full width of the swatter head. The polygonal peripheral outline distinguishes the swatter head geometry of the present invention from conventional fly swatters, which typically employ rounded, circular, or oval swatter head geometries. The straight edges of the polygonal peripheral outline provide defined contact lines that assist the user in aligning the swatter head with edges of surfaces, corners, and other architectural features where insects commonly rest. Peripheral edge 32 is preferably rounded or chamfered at its outermost margin to eliminate sharp edges that might mar surfaces upon impact or present a risk of laceration during handling.

Referring again collectively to FIGS. 1 through 3, fly swatter device 10 preferably comprises a dual-material or dual-durometer construction in which elongated handle 12 comprises a first polymer material having a first flexural rigidity and striking surface 22 comprises a second polymer material having a second flexural rigidity less than the first flexural rigidity of the first polymer material. As used herein, the term “flexural rigidity” refers to the resistance of the material to bending under an applied load, and is a function of both the elastic modulus of the material and the geometry of the cross-section. The differential flexural rigidity between elongated handle 12 and striking surface 22 ensures that elongated handle 12 resists deflection during a striking motion, providing the user with positive tactile control over the strike trajectory and transmitting the user's applied force efficiently to swatter head 18, while striking surface 22 exhibits controlled flexibility upon impact with a target surface, absorbing and distributing impact energy rather than transmitting concentrated impact forces to the underlying surface. The differential flexural rigidity between elongated handle 12 and striking surface 22 further provides a substantial durability advantage over conventional fly swatter designs, which are typically constructed from a single, uniform polymer material throughout the handle and striking surface. In conventional single-material construction, the designer must compromise between a material that is rigid enough to resist handle deflection during use and a material that is flexible enough to absorb impact energy at the striking surface without fracture. This compromise invariably results in a device that is either too rigid at the striking surface—leading to brittle fracture upon repeated impact—or too flexible at the handle—leading to poor strike control and progressive fatigue failure at the head-to-handle junction. The dual-material or dual-durometer construction of the present invention eliminates this compromise by independently optimizing the rigidity of the handle and the flexibility of the striking surface, producing a device that resists breakage under repeated high-force impact cycles that would fracture or permanently deform a conventional single-material fly swatter of comparable weight and cross-sectional geometry.

The first polymer material of elongated handle 12 is preferably selected from rigid engineering thermoplastics including, but not limited to, acrylonitrile butadiene styrene (ABS), nylon (polyamide), glass-fiber reinforced polypropylene, polycarbonate, acetal copolymer (polyoxymethylene), and combinations thereof. The first polymer material preferably exhibits a flexural modulus of from approximately 1,500 MPa to approximately 4,000 MPa as measured in accordance with ASTM D790. The second polymer material of striking surface 22 is preferably selected from the transparent polymers set forth herein, with the additional requirement that the second polymer material exhibit a flexural modulus less than the flexural modulus of the first polymer material. In a preferred embodiment, the second polymer material exhibits a flexural modulus of from approximately 500 MPa to approximately 2,500 MPa as measured in accordance with ASTM D790.

The dual-material construction may be achieved through a variety of manufacturing techniques including, but not limited to, two-shot injection molding, in which the first polymer material and the second polymer material are sequentially injected into a common mold; insert molding, in which a pre-formed handle of the first polymer material is placed into a mold cavity and the second polymer material is injected around or adjacent the handle to form the swatter head; overmolding, in which one polymer material is molded over a previously molded component of the other material; co-extrusion; mechanical fastening of separately molded handle and head components; adhesive bonding of separately molded components; and ultrasonic welding of separately molded components. In embodiments where swatter head 18 is integrally formed with elongated handle 12 as a unitary molded structure from a single polymer material, the differential flexural rigidity between the handle and the striking surface may be achieved through the geometry of the respective cross-sections—specifically, the thicker, narrower cross-section of elongated handle 12 provides greater bending resistance than the thinner, broader cross-section of striking surface 22 even when both are formed from the same material.

Fly swatter device 10 preferably incorporates an antimicrobial agent distributed within the polymer matrix of at least one of striking surface 22 and elongated handle 12. The antimicrobial agent is configured to inhibit the growth, colonization, and proliferation of bacteria, fungi, mold, and other microorganisms on the surfaces of fly swatter device 10 between cleaning events. This antimicrobial function complements the ease-of-cleaning advantage provided by the non-porous construction of striking surface 22 by providing a secondary defense against microbial contamination during periods when the device is in use but has not been cleaned following one or more insect elimination events. The antimicrobial function is particularly relevant given that the biological remains of dispatched insects—comprising hemolymph, visceral tissue, and surface microorganisms carried by the insect—provide a nutrient-rich substrate capable of supporting rapid microbial proliferation if not promptly removed.

Suitable antimicrobial agents for incorporation into the polymer matrix of fly swatter device 10 include, but are not limited to, silver ion compounds including silver sodium hydrogen zirconium phosphate, silver-containing zeolites, and silver nanoparticles; zinc pyrithione; copper-based antimicrobial compounds including copper oxide and copper-infused polymer masterbatches; and combinations thereof. The antimicrobial agent is preferably incorporated into the polymer resin during compounding or masterbatch preparation prior to the molding process, such that the antimicrobial agent is uniformly distributed throughout the polymer matrix and is present at the surface of the molded article without the need for post-molding surface treatment or coating application. This integral incorporation method ensures that the antimicrobial function is permanent, does not wear off with cleaning or abrasion, and does not rely upon a surface coating that might delaminate, peel, or transfer to unintended surfaces during use.

The antimicrobial agent is preferably present in the polymer matrix in an amount of from approximately 0.1 to approximately 5.0 percent by weight of the polymer composition, more preferably from approximately 0.5 to approximately 3.0 percent by weight, and most preferably from approximately 0.5 to approximately 1.5 percent by weight. The loading level of the antimicrobial agent is selected to provide effective microbial inhibition while avoiding adverse effects on the optical transparency of striking surface 22, the mechanical properties of the polymer, or the processability of the polymer during molding operations. In embodiments where striking surface 22 is optically transparent, the antimicrobial agent is preferably selected and loaded at a concentration that does not reduce the visible light transmittance of striking surface 22 below the minimum threshold of approximately 80 percent set forth herein.

The first embodiment of fly swatter device 10 as described herein and illustrated in FIGS. 1 through 3 is particularly advantageous for users who prefer or require a conventional impact-based insect elimination method but who have been underserved by conventional fly swatter designs due to targeting difficulty, hygiene concerns, or surface damage issues. The integrated sighting system formed by the cooperation of transparent striking surface 22 and visual alignment aperture 24, optionally supplemented by visual alignment indicia 26, provides a degree of targeting precision that is unavailable in any known prior art fly swatter device. The non-porous, solid, optically transparent striking surface eliminates the hygiene, debris entrapment, and cleaning difficulties associated with perforated mesh designs. The graduated thickness profile, dual-material construction, and antimicrobial incorporation collectively provide a device of premium structural quality, durability, and sanitary performance that clearly differentiates the present invention from commodity fly swatter products.

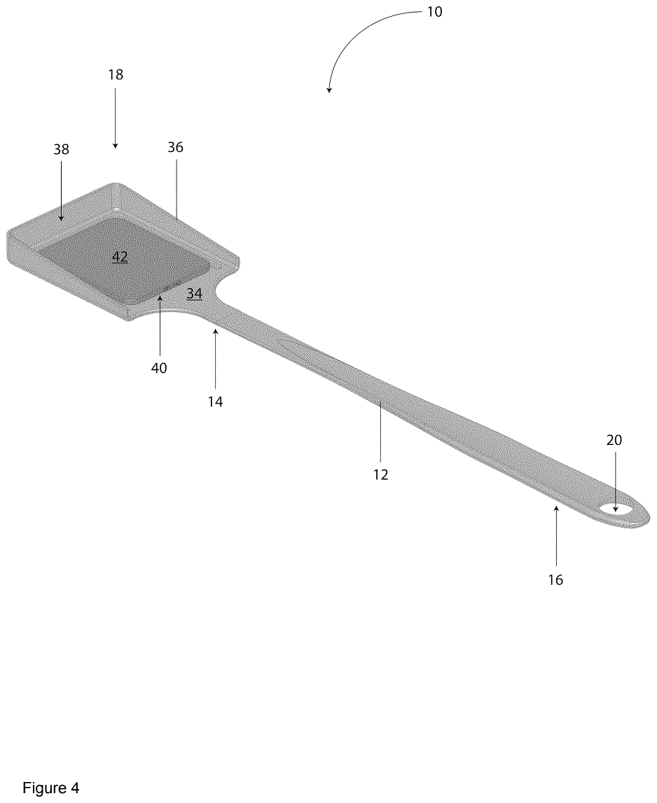

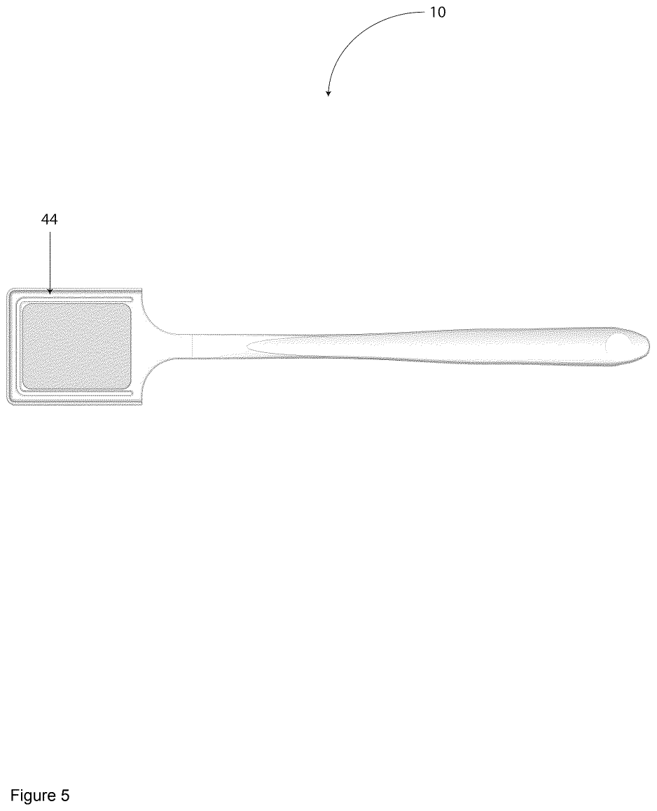

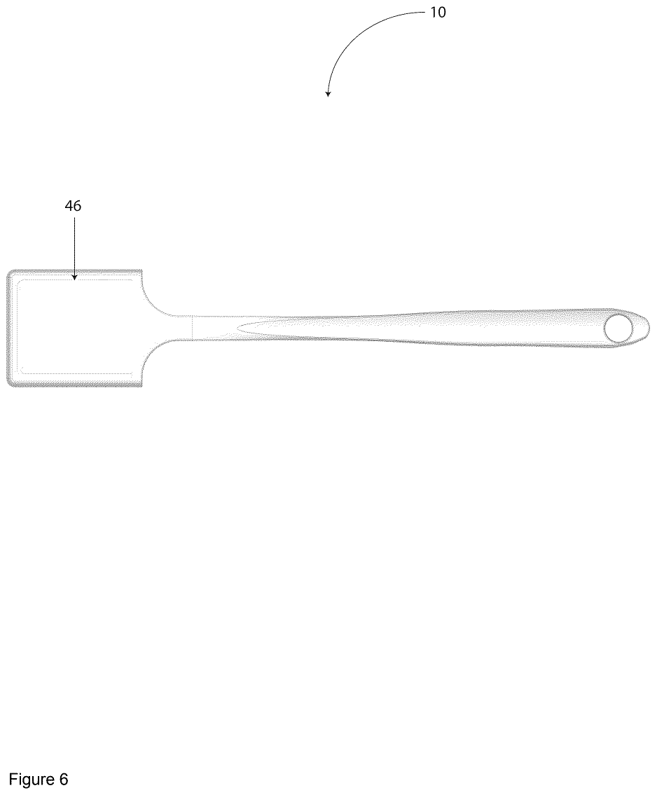

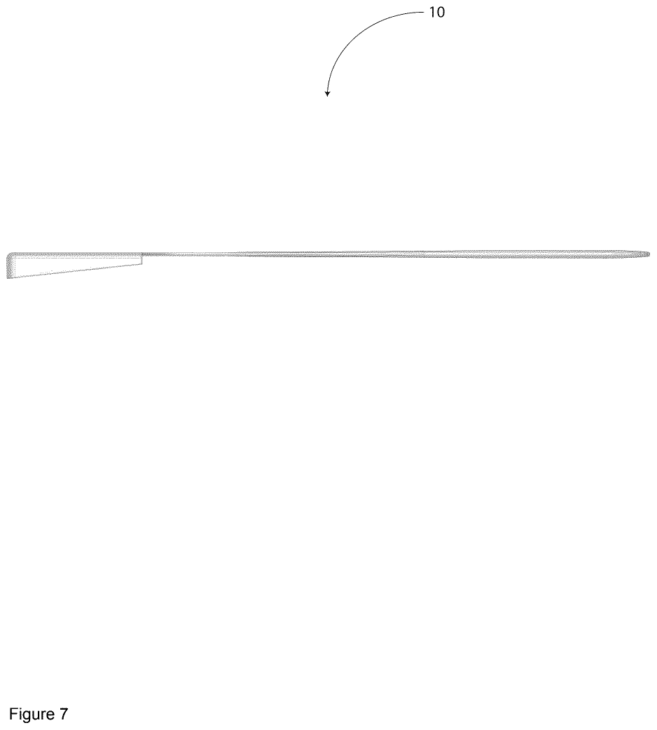

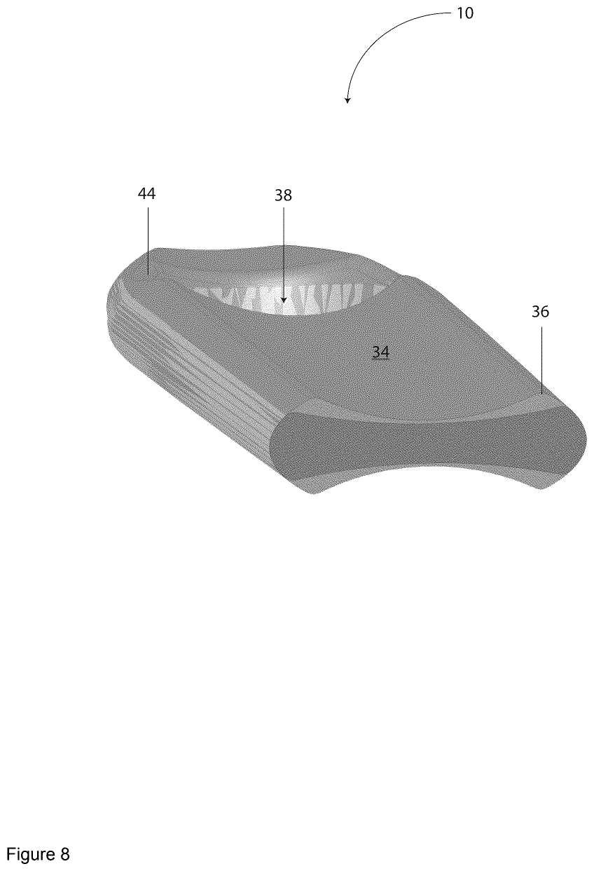

Referring now collectively to FIGS. 4 through 8, there is shown a fly swatter device 10 in accordance with a second embodiment of the present invention. The second embodiment of fly swatter device 10 is specifically engineered for the capture and removal of flying and resting insects through adhesive contact rather than impact force. FIG. 4 is a perspective view illustrating the overall three-dimensional form of the second embodiment, showing the swatter head with the adhesive gel pad installed. FIG. 5 is a top plan view illustrating the planar geometry of the swatter head and the adhesive gel pad seated within the retention region. FIG. 6 is a bottom plan view illustrating the underside of the swatter head and a flexibility slot formed therein. FIG. 7 is a side elevation view illustrating the profile of the swatter head, the raised perimeter containment wall, and the elongated handle extending therefrom. FIG. 8 is a cross-sectional detail view of the swatter head illustrating the containment wall geometry and the seating relationship between the gel pad and the retention region.

The second embodiment of fly swatter device 10 shares several structural elements with the first embodiment. Elongated handle 12, proximal end 14, distal end 16, and hanging aperture 20 are substantially as described above in connection with the first embodiment and serve the same respective functions. The description of these shared elements set forth in paragraphs [0050] through [0052] is incorporated herein by reference to the second embodiment and is not repeated in full for the sake of conciseness. It will be understood that the dimensions, materials, ergonomic features, and manufacturing alternatives described for the shared elements in connection with the first embodiment are equally applicable to the second embodiment unless otherwise indicated. The common design platform shared between the first and second embodiments enables manufacturing economies and provides the consumer with the option of selecting the functional modality—precision impact elimination or adhesive capture—best suited to the user's physical capabilities and the particular insect encounter scenario. In certain embodiments of the second embodiment, swatter head 18 may further incorporate a visual alignment aperture formed through a portion of the swatter head adjacent to or outside of retention region 38, substantially as described in connection with visual alignment aperture 24 of the first embodiment. The visual alignment aperture in the second embodiment provides the user with a sighting reference that assists in positioning exposed adhesive capture surface 42 relative to the target insect during the approach motion. The visual alignment aperture may optionally be surrounded by visual alignment indicia substantially as described in connection with visual alignment indicia 26 of the first embodiment. In such embodiments, the portion of swatter head 18 through which the visual alignment aperture is formed is preferably optically transparent or optically translucent to enable the user to see through the swatter head in the region surrounding the aperture, while the portion of swatter head 18 defining retention region 38 may be opaque.

The second embodiment of fly swatter device 10 differs from the first embodiment in the construction and function of swatter head 18. In the second embodiment, swatter head 18 comprises a substantially planar base surface 34 bounded by a raised perimeter containment wall 36. Base surface 34 is the lower structural surface of swatter head 18, defining the floor of the containment structure within which the adhesive gel pad is retained. Base surface 34 is preferably substantially flat or may incorporate a shallow concave curvature that assists in centering and retaining the adhesive gel pad. Base surface 34 is preferably non-porous and smooth to facilitate cleaning of the swatter head in the event that the adhesive gel pad is removed for replacement, and to prevent accumulation of biological debris beneath the adhesive gel pad.

Raised perimeter containment wall 36 extends upwardly from base surface 34 along the peripheral boundary of the swatter head and defines the lateral boundaries of the containment structure. Raised perimeter containment wall 36 projects above the plane of base surface 34 by a height that is sufficient to laterally contain the adhesive gel pad and to provide mechanical retention against lateral displacement of the pad during use, while not projecting so far above the adhesive capture surface as to interfere with the user's ability to bring the adhesive surface into contact with a target insect positioned on a surface. The height of raised perimeter containment wall 36 above base surface 34 is preferably from approximately 1.0 mm to approximately 6.0 mm, more preferably from approximately 2.0 mm to approximately 4.0 mm, and most preferably from approximately 2.5 mm to approximately 3.5 mm.

Raised perimeter containment wall 36 and base surface 34 together define a retention region 38. Retention region 38 is the recessed area bounded laterally by the inner faces of raised perimeter containment wall 36 and bounded on the bottom by base surface 34, and constitutes the receptacle within which the adhesive gel pad is received and retained. Retention region 38 is preferably substantially rectangular in plan view, corresponding to the rectangular geometry of the adhesive gel pad, although alternative geometries including square, circular, oval, and polygonal configurations are contemplated within the scope of the invention. The plan dimensions of retention region 38 are selected to provide a close but not interference fit with the corresponding plan dimensions of the adhesive gel pad, permitting the user to install and remove the gel pad without tools while providing sufficient lateral constraint to prevent the pad from shifting during use.

Referring now to FIGS. 4-8, an adhesive gel pad 40 is disposed within retention region 38. Adhesive gel pad 40 has an exposed adhesive capture surface 42 that faces outwardly from swatter head 18 when the gel pad is installed in retention region 38. Exposed adhesive capture surface 42 constitutes the functional insect-contacting surface of the second embodiment and is configured to capture and retain insects through adhesion upon contact with the target insect without requiring impact force sufficient to eliminate the insect. In operation, the user holds fly swatter device 10 by elongated handle 12, positions swatter head 18 proximate to the target insect, and brings exposed adhesive capture surface 42 into contact with the target insect. The engineered tackiness of adhesive gel pad 40 secures the insect to exposed adhesive capture surface 42 upon contact, enabling the user to lift the captured insect away from the surface on which it was resting and dispose of the insect and the spent gel pad together, or to peel the captured insect from the gel pad and continue using the same pad for subsequent captures.

The adhesive capture mechanism of the second embodiment represents a fundamentally different operational paradigm from both the impact elimination method of the first embodiment and the impact method of conventional fly swatters. The impact elimination method requires the user to generate sufficient striking velocity and force to dispatch the target insect upon contact —a demanding psychomotor task that requires the coordinated integration of visual targeting, rapid motor execution, grip strength, and upper extremity range of motion. The adhesive capture method, by contrast, requires only that the user bring exposed adhesive capture surface 42 into contact with the target insect at any speed, from any angle, and with minimal force. The contact need not be rapid, need not be forceful, and need not be precisely targeted to a specific point on the insect body. Any contact between exposed adhesive capture surface 42 and any portion of the target insect is sufficient to effect capture. This dramatically reduced demand on speed, force, coordination, and targeting precision renders the adhesive capture embodiment particularly advantageous for elderly users, individuals with arthritis or other conditions affecting grip strength and manual dexterity, individuals with Parkinson's disease or other neurological conditions affecting motor control, individuals with reduced visual acuity or contrast sensitivity, and individuals recovering from upper extremity injuries or surgical procedures.

Adhesive gel pad 40 preferably comprises a gel-based adhesive substance having specific characteristics engineered for insect capture applications. Adhesive gel pad 40 preferably exhibits appropriate tackiness to effectively capture insects upon contact while preventing excessive adhesion that might cause the gel pad to adhere to unintended surfaces or resist removal from retention region 38. Adhesive gel pad 40 preferably comprises a non-toxic, non-drying adhesive formulation suitable for household environments. As used herein, the term “non-toxic” means that the adhesive formulation does not contain ingredients classified as acutely toxic, carcinogenic, mutagenic, or reproductive toxicants under the Globally Harmonized System of Classification and Labelling of Chemicals (GHS) at the concentrations present in the formulation. As used herein, the term “non-drying” means that the adhesive formulation maintains its engineered tackiness over an extended period of at least approximately 30 days under normal indoor ambient conditions of from approximately 18° C. to approximately 27° C. and from approximately 30 to approximately 70 percent relative humidity, without the application of solvents, water, heat, or other reactivation treatment. In certain embodiments, exposed adhesive capture surface 42 may incorporate a surface texture comprising a plurality of grooves, ribs, channels, or raised ridges formed in or on the adhesive surface. The surface texture features may be oriented longitudinally along the length of adhesive gel pad 40, laterally across the width of adhesive gel pad 40, or in a combination of longitudinal and lateral orientations forming a cross-hatched or grid pattern. The surface texture features serve to displace water, condensation, or other moisture from exposed adhesive capture surface 42 upon contact with a target surface, thereby restoring or accelerating the effective tackiness of the adhesive surface under humid or damp conditions. The grooves or channels between adjacent ribs or ridges function as drainage pathways that direct moisture away from the contact interface between the adhesive surface and the target insect, ensuring that a thin film of water does not interpose between the adhesive and the insect body and thereby diminish the adhesive capture function. The surface texture features preferably have a depth of from approximately 0.1 mm to approximately 1.0 mm and a spacing of from approximately 0.5 mm to approximately 3.0 mm between adjacent features.

Suitable adhesive technologies for adhesive gel pad 40 include, but are not limited to, silicone-based pressure-sensitive adhesives, polyacrylate pressure-sensitive adhesive formulations, polyurethane gel adhesives, polyvinyl alcohol-based compositions, styrenic block copolymer-based gel compositions, and proprietary gel compounds specifically engineered for insect capture applications. The adhesive formulation of adhesive gel pad 40 is preferably characterized by a peel adhesion strength, as measured in accordance with ASTM D3330 on a stainless steel test panel, of from approximately 0.5 N/25 mm to approximately 5.0 N/25 mm, more preferably from approximately 1.0 N/25 mm to approximately 3.0 N/25 mm. This range of peel adhesion strength is sufficient to capture and retain insects of the sizes commonly encountered in residential environments—including houseflies, fruit flies, gnats, mosquitoes, and similar small flying insects—while remaining sufficiently low to permit the user to peel the gel pad from retention region 38 for replacement and to avoid aggressive adhesion to skin, clothing, or household surfaces in the event of accidental contact.

Adhesive gel pad 40 preferably further incorporates an antimicrobial agent configured to inhibit microbial colonization of captured insect remains on exposed adhesive capture surface 42. The antimicrobial function is particularly relevant in the adhesive capture embodiment because captured insects and their associated biological residue remain adhered to exposed adhesive capture surface 42 for an indeterminate period between the capture event and the disposal or replacement of the gel pad. During this retention period, the proteinaceous insect remains provide a nutrient substrate capable of supporting bacterial and fungal growth if not inhibited. Suitable antimicrobial agents for incorporation into adhesive gel pad 40 include the silver ion compounds, zinc pyrithione, and copper-based antimicrobial compounds described hereinabove in connection with the first embodiment, as well as additional antimicrobial agents that are compatible with adhesive gel formulations including quaternary ammonium compounds, chitosan derivatives, and triclosan-free organic antimicrobial agents. The antimicrobial agent may be incorporated directly into the adhesive gel formulation during compounding, or may be applied as a surface treatment to exposed adhesive capture surface 42.

Adhesive gel pad 40 is preferably removably disposed within retention region 38 and is replaceable by a user without the need for tools, adhesives, or specialized equipment. The removability and replaceability of adhesive gel pad 40 is a key functional attribute that enables extended service life of fly swatter device 10 by treating the gel pad as a consumable element that is periodically replaced while retaining the durable handle and swatter head structure. The replacement interval for adhesive gel pad 40 will depend upon the frequency of use, the number and size of insects captured, and the environmental conditions to which the device is exposed, but in typical residential use is expected to range from approximately one week to approximately three months between replacements. In alternative embodiments, adhesive gel pad 40 may comprise a refreshable gel formulation that can be cleaned with a specific solvent, warm water, or mechanical wiping to restore adhesive properties and remove captured insect remains, thereby extending the useful life of an individual gel pad through multiple cleaning and reuse cycles before ultimate replacement.

Referring now particularly to FIGS. 4-8, raised perimeter containment wall 36 preferably defines a recessed channel 44 dimensioned to receive and mechanically retain adhesive gel pad 40 within retention region 38. Recessed channel 44 is formed in the inner face of raised perimeter containment wall 36 and extends along at least a portion of the perimeter of retention region 38, and preferably along substantially the entire perimeter. Recessed channel 44 provides a mechanical interlock between the peripheral edge of adhesive gel pad 40 and raised perimeter containment wall 36, securing adhesive gel pad 40 against unintended detachment from swatter head 18 during normal use including handling, striking motions in which the device is used to press the gel pad against a target insect on a surface, and inverted storage positions in which swatter head 18 faces downward. The cross-sectional geometry of recessed channel 44 is preferably rectangular, trapezoidal, or dovetail-shaped, and is dimensioned to receive the peripheral edge of adhesive gel pad 40 in a friction fit or snap fit relationship. The depth of recessed channel 44 is preferably from approximately 0.5 mm to approximately 3.0 mm, and the width of recessed channel 44 is preferably from approximately 0.5 mm to approximately 2.0 mm. Referring additionally to FIG. 8, the cross-sectional detail view illustrates the seating relationship between adhesive gel pad 40 and the containment wall geometry, including the profile of recessed channel 44.

Referring now particularly to FIG. 6, a flexibility slot 46 is formed in the underside of swatter head 18. Flexibility slot 46 is visible in the bottom plan view of FIG. 6 and comprises a generally C-shaped or arcuate slot extending partially through the thickness of swatter head 18 in the region underlying base surface 34. Flexibility slot 46 does not extend completely through the thickness of swatter head 18, such that base surface 34 remains continuous and intact on the upper face of the swatter head. Flexibility slot 46 creates a living hinge zone in the swatter head structure that permits controlled flexure of the planar region of swatter head 18 overlying the slot. This controlled flexure serves multiple functional purposes.

First, flexibility slot 46 enables the region of swatter head 18 containing retention region 38 to deflect slightly upon contact with a target surface, absorbing impact energy and distributing contact forces rather than transmitting concentrated impact loads to the underlying surface. This impact absorption function protects surfaces against damage when the user presses the adhesive gel pad against an insect positioned on a wall, window, painted surface, or furnishing. Second, flexibility slot 46 permits base surface 34 and the adhesive gel pad seated thereon to conform to the contour of the target surface, improving the contact area between exposed adhesive capture surface 42 and the target surface and thereby increasing the probability that the target insect will be contacted by the adhesive surface even when the target surface is slightly curved, textured, or irregular. Third, flexibility slot 46 facilitates removal and replacement of adhesive gel pad 40 by enabling the user to flex the swatter head slightly to disengage the peripheral edge of the gel pad from recessed channel 44, without requiring the user to apply excessive prying force that might damage the containment wall or the gel pad.

Flexibility slot 46 is preferably from approximately 0.5 mm to approximately 2.0 mm in width and extends through from approximately 30 percent to approximately 70 percent of the total thickness of swatter head 18 at the location of the slot. The C-shaped or arcuate configuration of flexibility slot 46 is oriented such that the open end of the C-shape faces generally toward elongated handle 12, permitting the greatest degree of flexure at the distal and lateral margins of the swatter head while maintaining structural continuity at the head-to-handle transition region where rigidity is most needed. In alternative embodiments, flexibility slot 46 may comprise a U-shaped, V-shaped, or linear slot configuration, or may comprise a plurality of discrete slot segments arranged in a pattern that provides the desired flexural characteristics for the particular swatter head geometry and gel pad retention requirements.

The second embodiment of fly swatter device 10 may be constructed from the same material families described in connection with the first embodiment for elongated handle 12, with the swatter head structure preferably constructed from a polymer material that provides the combination of structural rigidity, impact resistance, and chemical inertness required to retain adhesive gel pad 40 without degradation of the containment wall or base surface by adhesive migration from the gel pad. Suitable materials for the swatter head structure of the second embodiment include, but are not limited to, polypropylene, ABS, nylon, polycarbonate, and glass-fiber reinforced polypropylene. Unlike the first embodiment, the swatter head of the second embodiment need not be optically transparent because the second embodiment does not rely upon visual sighting through the striking surface for targeting. Accordingly, the swatter head of the second embodiment may be opaque, pigmented, or colored as desired for aesthetic, branding, or manufacturing considerations.

The second embodiment of fly swatter device 10 as described herein and illustrated in FIGS. 4 through 8 is particularly advantageous for users who prefer or require a non-impact insect capture method, including elderly users, individuals with reduced grip strength or limited upper extremity range of motion, individuals with motor control deficiencies, and individuals who prioritize clean, residue-free insect disposal over the immediacy of impact elimination. The adhesive capture approach eliminates the need for forceful strikes against household surfaces, thereby preventing both surface damage and the dispersion of insect remains that characterize conventional impact-based methods. The replaceable gel pad architecture provides a practical, low-cost consumable replenishment model that extends the useful life of the durable device structure indefinitely.

The present invention further encompasses methods of capturing and eliminating insects using fly swatter device 10 in accordance with both the first and second embodiments. The methods described hereinbelow represent the inventors' contemplated modes of practicing the invention and provide a complete understanding of the operational principles underlying the structural features described above.

In a first method of use corresponding to the first embodiment, the user provides fly swatter device 10 having elongated handle 12 connected to swatter head 18, swatter head 18 comprising optically transparent, non-porous, solid striking surface 22 and visual alignment aperture 24 formed therethrough. The user grasps elongated handle 12 and visually acquires the target insect through transparent striking surface 22. The user aligns visual alignment aperture 24 with the target insect by positioning fly swatter device 10 such that the target insect is visible within or immediately adjacent visual alignment aperture 24 as viewed through striking surface 22. The user then executes a striking motion while maintaining visual contact with the target insect through striking surface 22 and visual alignment aperture 24, delivering striking surface 22 to the target insect at sufficient velocity and force to eliminate the insect upon impact. Following the strike, the user inspects striking surface 22, locates the insect remains on the smooth, non-porous exterior surface of striking surface 22 or on the target surface, and removes the insect remains by simple wiping with a cloth, paper towel, or other cleaning medium. The non-porous construction of striking surface 22 facilitates this cleaning step by confining the insect remains to the exterior surface without entrapment in mesh openings or perforations.

In a second method of use corresponding to the second embodiment, the user provides fly swatter device 10 having elongated handle 12 connected to swatter head 18, swatter head 18 comprising base surface 34, raised perimeter containment wall 36 defining retention region 38, and adhesive gel pad 40 disposed within retention region 38 with exposed adhesive capture surface 42 facing outwardly. The user grasps elongated handle 12 and positions swatter head 18 proximate to the target insect. The user brings exposed adhesive capture surface 42 into contact with the target insect at any speed and with minimal force. The engineered tackiness of adhesive gel pad 40 secures the insect to exposed adhesive capture surface 42 upon contact. The user lifts fly swatter device 10 away from the surface, carrying the captured insect adhered to exposed adhesive capture surface 42. The user then disposes of the captured insect by peeling it from exposed adhesive capture surface 42 or by removing and replacing adhesive gel pad 40 with a fresh pad when the capture surface has accumulated a sufficient number of insects or has otherwise reached the end of its useful service interval.

In both methods of use, the user may store fly swatter device 10 between use events by suspending the device from hanging aperture 20 on a hook, nail, or other support element, maintaining the device in a readily accessible location for immediate deployment upon sighting of a target insect. It will be understood that the specific embodiments described herein are illustrative and not limiting, and that numerous variations, substitutions, and combinations are contemplated within the scope of the invention. By way of non-limiting example, the first embodiment of fly swatter device 10 may be practiced without visual alignment aperture 24, such that striking surface 22 comprises an optically transparent or optically translucent, non-porous, solid striking surface without any aperture formed therethrough, the transparent or translucent striking surface alone providing the user with visual feedback regarding the position of the target insect during the approach and striking motion. Additionally, the adhesive gel pad 40 of the second embodiment may be replaced by or supplemented with alternative adhesive capture media including, but not limited to, double-sided adhesive tape, adhesive film sheets, repositionable adhesive note material, adhesive-coated paper or polymer substrates, replaceable adhesive sticker pads, wax-based capture coatings, spray-applied tack surfaces, or any other adhesive or tacky medium capable of capturing and retaining an insect upon contact, whether permanently affixed to the swatter head, removably retained within retention region 38, or applied by the user as a consumable overlay. Further, features described in connection with one embodiment may be incorporated into the other embodiment where not structurally incompatible, including without limitation the incorporation of visual alignment aperture 24 and visual alignment indicia 26 into the second embodiment, the application of an adhesive capture medium to striking surface 22 of the first embodiment, and the combination of a transparent or translucent striking surface with an adhesive capture surface in a single hybrid swatter head configuration. Additionally, the visual alignment function described herein may be achieved through visual alignment indicia alone without a physical aperture, through a physical aperture alone without surrounding indicia, or through the combination of both, as described herein.

In certain embodiments of the first embodiment, the striking surface 22 is characterized by a surface energy that is specifically selected to minimize adhesion of insect remains to the striking surface following impact. Striking surface 22 preferably exhibits a water contact angle of from approximately 90 degrees to approximately 120 degrees as measured by the sessile drop method in accordance with ASTM D7334, indicative of a hydrophobic surface character. This hydrophobic surface character causes proteinaceous insect residue, hemolymph, and other biological fluids deposited on striking surface 22 during impact to bead and resist wetting of the surface, thereby weakening the adhesive bond between the residue and the striking surface and facilitating removal by simple wiping with minimal effort. The hydrophobic surface character may be achieved through selection of an inherently hydrophobic polymer for striking surface 22, through incorporation of a hydrophobic additive into the polymer matrix during compounding, or through application of a permanent or semi-permanent hydrophobic surface treatment such as a plasma-deposited fluorocarbon coating, a silane-based surface modification, or a nanostructured superhydrophobic surface treatment. The combination of optical transparency, non-porous construction, and engineered hydrophobic surface energy in a single striking surface is believed to be without precedent in the fly swatter art and provides a synergistic cleaning advantage in which insect remains are simultaneously prevented from penetrating the surface, prevented from strongly adhering to the surface, and rendered readily visible on the transparent surface for targeted removal.

In certain embodiments of the first embodiment, the geometric relationship between visual alignment aperture 24 and swatter head 18 is defined by a sighting ratio. As used herein, the sighting ratio is defined as the ratio of the major axis dimension of visual alignment aperture 24 to the maximum width dimension of swatter head 18, measured in the same plane. The sighting ratio is preferably from approximately 0.05 to approximately 0.25, more preferably from approximately 0.08 to approximately 0.18, and most preferably from approximately 0.10 to approximately 0.15. A sighting ratio below approximately 0.05 results in an aperture that is too small to provide effective visual acquisition of the target insect at typical operating distances, while a sighting ratio above approximately 0.25 results in an aperture that is sufficiently large to compromise the structural integrity of striking surface 22 in the region surrounding the aperture and to reduce the effective striking area available for insect contact. The inventor has determined that a sighting ratio of from approximately 0.10 to approximately 0.15 provides an optimal balance between visual acquisition field, alignment precision, structural integrity, and effective striking area for swatter head widths in the range of from approximately 3.5 inches to approximately 5.5 inches. The sighting ratio as a defined geometric parameter governing the visual alignment function of a fly swatter is believed to be a novel concept without precedent in the prior art.

In certain embodiments of the first embodiment, striking surface 22 exhibits a tuned resonant frequency that minimizes transmitted vibration feedback to the user's hand upon impact. The resonant frequency of striking surface 22 is a function of the material elastic modulus, the material density, the thickness profile, the planar geometry, and the boundary conditions at head-to-handle transition zone 28. The inventors have recognized that a striking surface having a first natural frequency of vibration above approximately 80 Hz tends to produce a crisp, well-damped impact sensation that communicates positive tactile confirmation of a successful strike, whereas a striking surface having a first natural frequency below approximately 40 Hz tends to produce a lingering, low-frequency vibration that the user perceives as uncontrolled flexing and that may cause secondary bouncing of the swatter head away from the target surface, potentially allowing the struck insect to escape. Striking surface 22 preferably exhibits a first natural frequency of vibration of from approximately 60 Hz to approximately 150 Hz, more preferably from approximately 80 Hz to approximately 120 Hz, as determined by the combination of polymer selection, thickness profile, and planar geometry described herein. This tuned vibrational response provides the user with immediate tactile feedback confirming successful insect contact while minimizing the rebound behavior that reduces effectiveness in conventional flexible-mesh fly swatter designs.

In certain embodiments of either the first or second embodiment, elongated handle 12 incorporates a thermal isolation feature that reduces or prevents conduction of the user's body heat from the hand gripping the handle to swatter head 18. Many species of flying insects, including the common housefly, possess infrared-sensitive thermoreceptors capable of detecting thermal gradients at distances of several centimeters. A fly swatter head that has been warmed by conduction of body heat from the user's gripping hand may present a detectable thermal signature that alerts the target insect to the approaching threat, triggering an evasive flight response before the striking surface reaches the target. The thermal isolation feature may comprise a reduced cross-sectional area region of elongated handle 12 positioned between the gripping region and swatter head 18 that restricts conductive heat transfer, a segment of elongated handle 12 formed from a low thermal conductivity polymer such as polyoxymethylene, ultra-high molecular weight polyethylene, or a glass-fiber reinforced thermoplastic, an air gap or hollow section within the handle cross-section, or a combination of these approaches. The thermal conductivity of the handle segment between the gripping region and swatter head 18 is preferably less than approximately 0.30 W/(m·K), more preferably less than approximately 0.20 W/(m·K). The incorporation of a thermal isolation feature into a fly swatter handle for the purpose of reducing insect thermal detection is believed to be without precedent in the prior art.

In certain embodiments of the first embodiment, striking surface 22 incorporates an electrostatic dissipation feature that prevents accumulation of static electrical charge on the striking surface during use and storage. Static charge accumulation on polymer surfaces is a well-known phenomenon that can attract airborne dust, particulate debris, and lightweight insect fragments to the surface, progressively degrading the optical transparency of striking surface 22 and impairing the visual alignment function. Additionally, static charge accumulation may create a perceptible electrostatic field proximate to the striking surface that certain insect species may detect through mechanosensory setae, potentially alerting the target insect to the approaching device. Striking surface 22 preferably incorporates a permanent antistatic agent distributed within the polymer matrix, such as a glycerol monostearate, an ethoxylated amine, a quaternary ammonium salt, a conductive polymer additive such as polyaniline or poly(3,4-ethylenedioxythiophene), or a carbon nanotube or graphene-based conductive filler at loadings below the percolation threshold such that the additive does not materially reduce the visible light transmittance of striking surface 22 below the minimum threshold set forth herein. Alternatively or additionally, the surface of striking surface 22 may be treated with a permanent or semi-permanent antistatic surface coating. The surface resistivity of striking surface 22 is preferably from approximately 10⁹ to approximately 10¹² ohms per square as measured in accordance with ASTM D257, which is sufficient to dissipate static charge accumulation within seconds of the charging event while remaining well above the conductivity range that would present electrical safety concerns.

The foregoing description merely explains and illustrates the invention and the invention is not limited thereto except insofar as the appended claims are so limited, as those skilled in the art who have the disclosure before them will be able to make modifications without departing from the scope of the invention.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etcetera shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, compounds, compositions, materials, or manufacturing processes, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etcetera. As a non-limiting example, each range discussed herein can be readily broken down into a lower third, middle third and upper third, etcetera. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed and desired to be secured by Letters Patent of the United States is:

1. A fly swatter device, comprising:
an elongated handle having a proximal end and a distal end;
a swatter head connected to the proximal end of the elongated handle, the swatter head comprising a substantially planar striking surface, the striking surface being optically transparent, non-porous, and solid; and
a visual alignment aperture formed through the striking surface, the visual alignment aperture being positioned within the striking surface and configured to enable a user to maintain visual contact with a target insect through the striking surface during approach and striking motions, whereby the visual alignment aperture functions as an integrated sighting system for aligning the striking surface with the target insect.

2. The fly swatter device according to claim 1, wherein the visual alignment aperture is substantially oval or elliptical in configuration.

3. The fly swatter device according to claim 1, wherein the visual alignment aperture is substantially circular in configuration.

4. The fly swatter device according to claim 1, further comprising visual alignment indicia disposed on or adjacent the striking surface surrounding the visual alignment aperture, the visual alignment indicia configured to enhance visual targeting of the target insect.

5. The fly swatter device according to claim 4, wherein the visual alignment indicia comprise one or more features selected from the group consisting of concentric rings, crosshair markings, contrasting-color annular zones, radial tick marks, and combinations thereof.

6. The fly swatter device according to claim 1, wherein the striking surface comprises a transparent polymer having a visible light transmittance of at least approximately 80 percent as measured in accordance with ASTM D1003.

7. The fly swatter device according to claim 6, wherein the transparent polymer incorporates a UV stabilizer configured to resist photodegradation and yellowing of the striking surface over prolonged exposure to ultraviolet radiation.

8. The fly swatter device according to claim 1, wherein the striking surface exhibits a graduated thickness profile, being thicker at a head-to-handle transition zone where the swatter head connects to the elongated handle and progressively thinner toward a distal perimeter of the swatter head, whereby the graduated thickness profile provides structural rigidity at the head-to-handle transition zone while permitting controlled flexibility at the distal perimeter of the striking surface.

9. The fly swatter device according to claim 1, wherein the striking surface comprises a transparent polymer selected from the group consisting of polycarbonate, polymethyl methacrylate, clarified polypropylene, cyclic olefin copolymer, styrene-acrylonitrile copolymer, and combinations thereof.

10. The fly swatter device according to claim 1, wherein at least one of the striking surface and the elongated handle incorporates an antimicrobial agent distributed within a polymer matrix thereof, the antimicrobial agent selected from the group consisting of silver ion compounds, zinc pyrithione, copper-based antimicrobial compounds, and combinations thereof.

11. The fly swatter device according to claim 1, wherein the elongated handle comprises a first polymer material having a first flexural rigidity and the striking surface comprises a second polymer material having a second flexural rigidity less than the first flexural rigidity, whereby the elongated handle resists deflection during a striking motion while the striking surface exhibits controlled flexibility upon impact with a target surface.

12. The fly swatter device according to claim 1, wherein the elongated handle includes a hanging aperture formed through the distal end thereof, the hanging aperture configured to receive a hook or fastener for suspended storage of the device.

13. The fly swatter device according to claim 1, wherein the swatter head is integrally formed with the elongated handle as a unitary molded structure.

14. The fly swatter device according to claim 1, wherein the swatter head comprises a polygonal peripheral outline having at least five straight edges.

15. A fly swatter device, comprising:
an elongated handle having a proximal end and a distal end;
a swatter head connected to the proximal end of the elongated handle, the swatter head comprising a substantially planar base surface bounded by a raised perimeter containment wall, the raised perimeter containment wall and the base surface together defining a retention region; and
an adhesive gel pad disposed within the retention region, the adhesive gel pad having an exposed adhesive capture surface configured to capture and retain insects through adhesion upon contact with a target insect without requiring impact force sufficient to eliminate the insect.

16. The fly swatter device according to claim 15, wherein the adhesive gel pad is removably disposed within the retention region and is replaceable by a user.

17. The fly swatter device according to claim 15, wherein the adhesive gel pad comprises a non-toxic, non-drying adhesive formulation, and wherein the adhesive gel pad further incorporates an antimicrobial agent configured to inhibit microbial colonization of captured insect remains on the exposed adhesive capture surface.

18. The fly swatter device according to claim 15, wherein the raised perimeter containment wall defines a recessed channel dimensioned to receive and mechanically retain the adhesive gel pad, whereby the adhesive gel pad is secured against unintended detachment from the swatter head during normal use.

19. A fly swatter device, comprising:
an elongated handle having a proximal end and a distal end, the elongated handle comprising a first polymer material having a first flexural rigidity, the distal end of the elongated handle defining a hanging aperture formed therethrough;
a swatter head integrally formed with the elongated handle at the proximal end as a unitary molded structure, the swatter head comprising a substantially planar striking surface having a polygonal peripheral outline with at least five straight edges, the striking surface being optically transparent, non-porous, and solid, the striking surface comprising a second polymer material having a second flexural rigidity less than the first flexural rigidity of the elongated handle, the second polymer material being selected from the group consisting of polycarbonate, polymethyl methacrylate, clarified polypropylene, cyclic olefin copolymer, styrene-acrylonitrile copolymer, and combinations thereof, the second polymer material having a visible light transmittance of at least approximately 80 percent as measured in accordance with ASTM D1003, the second polymer material incorporating a UV stabilizer configured to resist photodegradation and yellowing, the striking surface exhibiting a graduated thickness profile being thicker at a head-to-handle transition zone and progressively thinner toward a distal perimeter of the swatter head;
a visual alignment aperture formed through the striking surface, the visual alignment aperture being substantially oval or elliptical in configuration and positioned within the striking surface to enable a user to maintain visual contact with a target insect through the striking surface during approach and striking motions;
visual alignment indicia disposed on or adjacent the striking surface surrounding the visual alignment aperture, the visual alignment indicia comprising one or more features selected from the group consisting of concentric rings, crosshair markings, contrasting-color annular zones, radial tick marks, and combinations thereof; and
an antimicrobial agent distributed within a polymer matrix of at least one of the striking surface and the elongated handle, the antimicrobial agent selected from the group consisting of silver ion compounds, zinc pyrithione, copper-based antimicrobial compounds, and combinations thereof.

20. A fly swatter device, comprising:
an elongated handle having a proximal end and a distal end, the distal end of the elongated handle defining a hanging aperture formed therethrough;
a swatter head connected to the proximal end of the elongated handle, the swatter head comprising a substantially planar base surface bounded by a raised perimeter containment wall, the raised perimeter containment wall and the base surface together defining a retention region, the raised perimeter containment wall further defining a recessed channel dimensioned to receive and mechanically retain an adhesive gel pad; and
an adhesive gel pad removably disposed within the retention region and within the recessed channel, the adhesive gel pad comprising a non-toxic, non-drying adhesive formulation having an exposed adhesive capture surface configured to capture and retain insects through adhesion upon contact without requiring impact force, the adhesive gel pad further incorporating an antimicrobial agent configured to inhibit microbial colonization of captured insect remains on the exposed adhesive capture surface.
